(19) United States
(12) Patent Application Publication
(10) Pub. No.: US 2010/0047023 A1
(43) Pub. Date: Feb. 25, 2010

(54) Subsea Pipeline Repair and Maintenance Tools and Method for Replacement of Broken Pipelines

(75) Inventor: Ingolf Horne, Tysne (NO)

Correspondence Address: Reed Smith, 3110 Fairview Park Drive, Suite1400, Falls Church, VA, 22042, US

(73) Assignee: AS CONNECTOR, Bergen (NO)

(21) Appl. No.: 12/224,786

(22) PCT Filed: Mar. 7, 2007
(86) PCT No.: PCT/NO2007/000091

§ 371 Date: Nov. 6, 2009

(30) Foreign Application Priority Data
Mar. 7, 2006 (NO) 20061102

(51) Int. Cl. F16L 55/18; F16L 21/00

(52) U.S. Cl. 405/184.1; 285/146.1

(57) ABSTRACT

A pipeline repair connector (40), for a sub sea pipeline repair system, arranged for connecting and disconnecting pipelines on the ocean floor. The invention also related to a system including a connector (40), and to a method for replacement of broken pipelines on the ocean floor.

The present invention relates to a pipeline repair connector, for a sub sea pipeline system, arranged to be lowered to the ocean floor for replacement of pipelines on the ocean floor, wherein the connector comprises a connector housing for gripping and sealing of the pipeline ends, and an inlet funnel for receipt of at least one of said pipeline ends. The invention further relates to a system for repair of pipelines, and a method for replacement of broken pipelines on the ocean floor.

There is an ever-increasing demand from the Oil and Gas industry to develop better equipment for the sub sea area that are smaller and simpler to handle and maintain. This equipment must allow for diver-less operations and are free from bolted and welded connections. The equipment should preferably also be hydraulically operated by ROV support only.

Within this market, there are many pipelines that are beginning to age, and the need for maintenance and repair is increasing. At the same time there are ever increasing tighter restrictions for the use of divers for such repairs. Consequently, there is an increasing demand for repair pipeline equipment to be fully ROV operated, and this is where the applicant has found a niche market, and gives oil companies their contingency plans for deep-water pipeline repairs deeper than was possible before.

The present repair connector is unique in its design and operation, comprising basically only three integrated weld less main parts, which will bring favorable cost-effective results to customers. By combining the hydraulic operated pipe sealing and gripping system together with the hydraulic operated Ball Joint and Quick Sealing Coupling System (HQS), as an integral weld less part of the connector, the equipment will be unique as it will be easy and quick to hydraulically connect and disconnect to pipelines. The system will make the existing use of flanges; stud bolts and nuts obsolete, and will represent a huge gain in operation and installation time for sub sea pipeline repairs in all applications.

There are many systems disclosing sub sea pipe handling equipment. Among others: NO 322062 regarding pulling in and connecting to the a pipe; U.S. Pat. No. 6,113,157 regarding a adjustable ball joint connector; EP-A1-733,843 regarding connecting underwater pipelines; NO-B-177,683 regarding repair of a sub sea pipeline; WO-A1-97/15773 regarding assembling installation on seabed, with a complicated piece of equipment to tighten or loosen bolt nuts on an ordinary flange, in a limited working area and depth. Other documents are: U.S. Pat. No. 4,868,964 regarding an apparatus for joining a pipe; US 2002/0179167 regarding a remotely operable closure device; and NO 910291 regarding inspection and cleaning of a pipe.

An object of the invention is thus to provide pipeline repair and maintenance tools, which are easy to operate and which, if necessary, can be deployed in deep water applications.

Said objects are achieved with a repair connector as defined in independent 1, wherein a first part of said housing comprises a pressurized gripping and sealing arrangement for receipt and gripping of an existing pipeline end in the connector housing, and a second part of said housing comprises a pressurized operated quick sealing light weight coupling (HQS) for receipt and gripping of a replacement pipe in the connector housing, and intermediate between said housing ends is a pressurized alignment ball joint, wherein all components are adapted to be hydraulically pressurized to a mechanical locking position and to provide a seal to the surrounding.

The above objects are also achieved with a system as defined in independent claim 9, and a method for replacement of broken pipelines on the ocean floor, as defined in independent claim 11.

Alternative embodiments are defined in the dependent claims 2-8, 10, and 12, respective.

An example embodiment of the invention shall now be described with the help of the enclosed drawings, wherein;

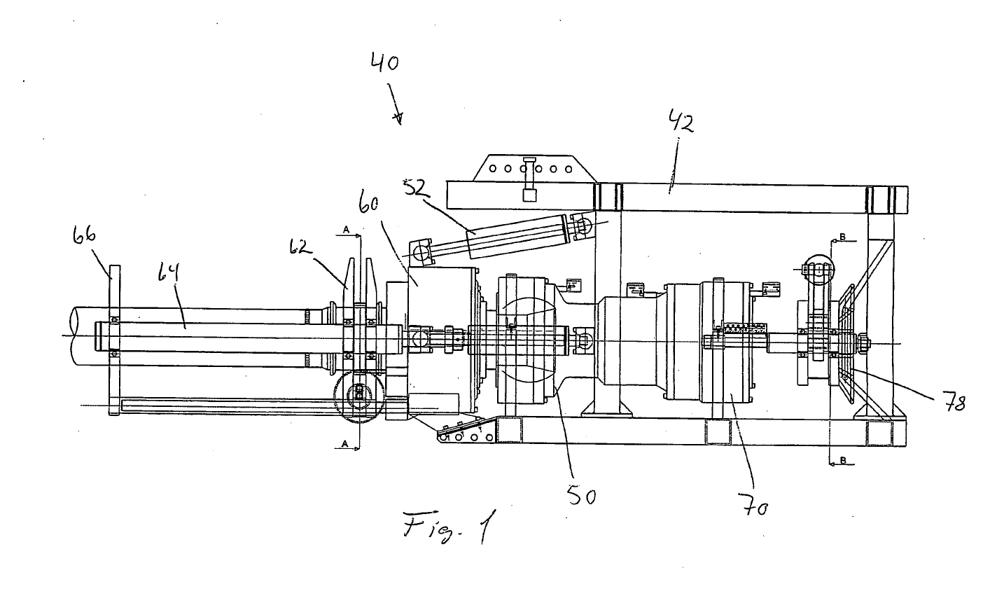

FIGS. 1-6 shows a connector according to the invention.

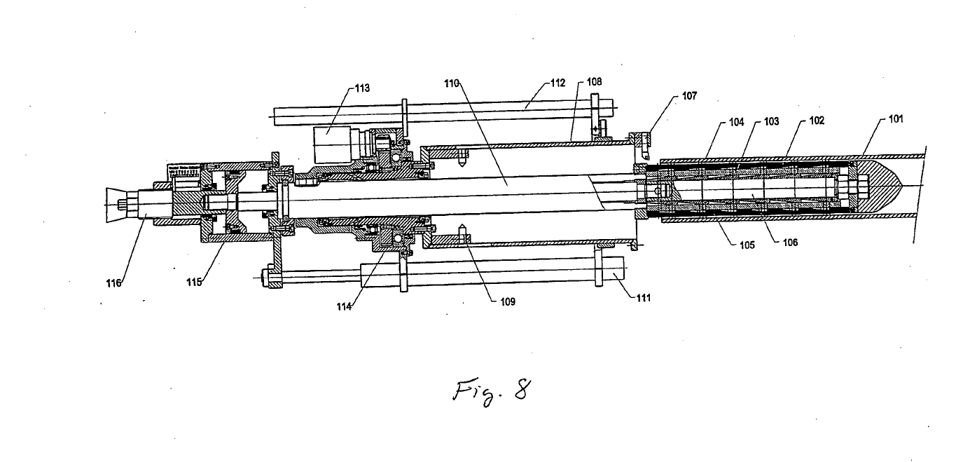

FIGS. 7 and 8 shows a preparation tool to be used in a system according to the invention.

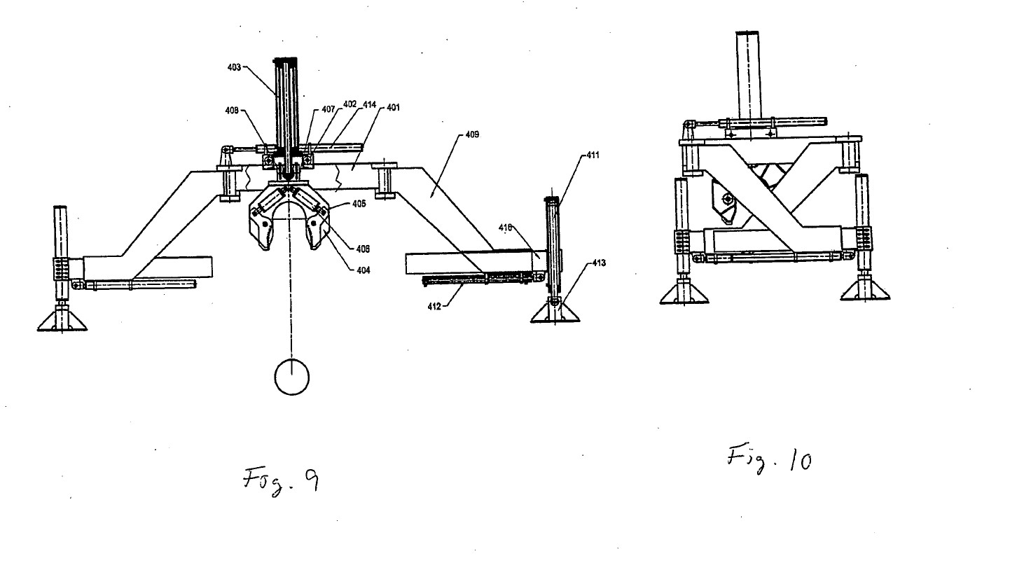

FIGS. 9 and 10 shows a lifting tool to be used in a system according to the invention.

The present connectors 40 are designed and prepared for instance for pipe from 4 inch O.D. to a maximum 20 inch O.D., with a pressure rating according to customer's requests. The connector is unique in its design and operation, comprising of preferable three (3) integrated weld less main parts, which will bring favourable cost-effective results to customers.

A pipe sealing and gripping system 70, a ball joint 50 and quick sealing coupling 60 system (HQS) have been combined in the connector 40 to produce a revolutionary piece of equipment. The equipment is simple and quick to hydraulically connect and disconnect pipelines. The system will make the existing flanges stud bolts and nuts obsolete, and will represent a huge saving in operation and installation time for sub sea pipeline repairs in all applications.

General advantages with the connector are diver-less ROV installation, no flange/bolt connections, and hydraulically operated pipe gripping and pipe sealing system. The hydraulically operated alignment “ball joint” allows at least 14-degree movement in any direction. The connector is optimized in design for low weight and easy operation. Cost effective in comparison with existing mechanical connectors. It can be designed specifically for Sour Services & Corrosion with high H2S & CO2. The connector can be equipped with a special “environmental seal” system that will seal and protect the pipe and gripping system from corrosion. The connector pipeline sealing system is especially designed for application down to at least 2000 meters. It has a slim and lightweight. Moderate cost and high performance. Can be produced for application from 4″ pipe to 20″ O.D.

The connector 40 consists mainly of three integrated weld-less main parts. A connector housing 6 for hydraulic operation of a pipe with the gripping and sealing arrangement 70; the hydraulically operated alignment ball joint 50 that allows for at least 14 degrees movement in any direction; and the hydraulically operated quick sealing lightweight coupling 60.

The connector can comprise a transport and installation frame 42 that has attached tool for easy sub sea pipeline repair and installation. The transport and installation frame can be equipped with the following permanent tools for easy installation and entering of pipes during sub sea pipeline repair work: Connector pulling tool—to position connector onto the ridge pipe in the right position. At least two hydraulic cylinders for position and adjustment of ball joint correct alignment, and replacement pipe pulling and retracting guide tool.

The hydraulically operated pipe sealing and gripping system 70 as shown in FIG. 5 comprises a seal set hydraulic system 72 preferable designed as a one position-locking device. When the connector 40 is in its position on the sub sea ridged pipeline during installation, the hydraulic closing pressure is applied to compress and “lock” in the seals in a compressed mode (position) on the pipe. The gripping hydraulic system can be designed with a (3-stage) multi-lock. With multi-lock it is capable of mechanically locking the gripping in position. The principle of operation is the same as above, but can consist of three sets of locking segments and a multi-locking cone. The position locking device eliminates the need for additional hydraulic control lines to operate the locks.

As shown in FIG. 5, a pipeline end 80, is after being prepared by a preparation tool, inserted in the sealing and gripping system 70. The seals 74 encloses the pipeline end 80 and the gripping means 76 are gripping and holding the pipeline in place. In front of the pipe sealing and gripping system 70 is a pipeline guide funnel 78 to guide the pipeline in place.

The hydraulically operated ball joint system 50 is one of the unique features of the new hydraulically operated ball joint of flex type connection, with for instance elastomer seals. It is designed to compensate misalignments of pipeline up to at least 14 degrees in any direction. The advantages of a hydraulically operated ball joint, is that it is easy to adjust, in the open position during installations, due to no forces between seals and ball joint. A large area in the operating piston/actuator creates high closing force to compress elastomer seals, and at the same time gives good strength of preload to the connection. The hydraulic actuator can be designed with a position lock device, to maintain seal and ball joint in contact, when the hydraulic system has a maximum internal pressure and maximum bending is achieved.

The hydraulic quick sealing system coupling 60 (HQS) between the connector 40 and the replacement pipe 82 is one of the main keys to success. The HQS coupling is preferably a hub/clamp 26 connection with a metal-to-metal sealing system. It is designed with one operating annular piston/actuator with a large piston area which creates a high closing force, combined with for example a 5 degree taper actuator ring and for example a 25 degree taper on the clamp segment and hubs to have good strength and preload of connection. The dynamic parts of the system are designed with a “position lock” device to maintain metal-to-metal (hub-to-hub) contact when systems maximum internal pressure and maximum bending moments have been achieved. The coupling metal-to-metal sealing system is designed with a metal gasket ring, which provides the high-pressure seal between the hubs. The sealing gasket ring is a unique sealing system that provides sealing from the outside to the inside of the pipe, and from the inside to the outside of the pipe, including pressure balance and system for external and internal testing. The coupling is “full bore” and has no restrictions in the internal diameter to cause venture effect, allowing laminar flow of fluid through the coupling. The metal gasket ring can be re-used many times.

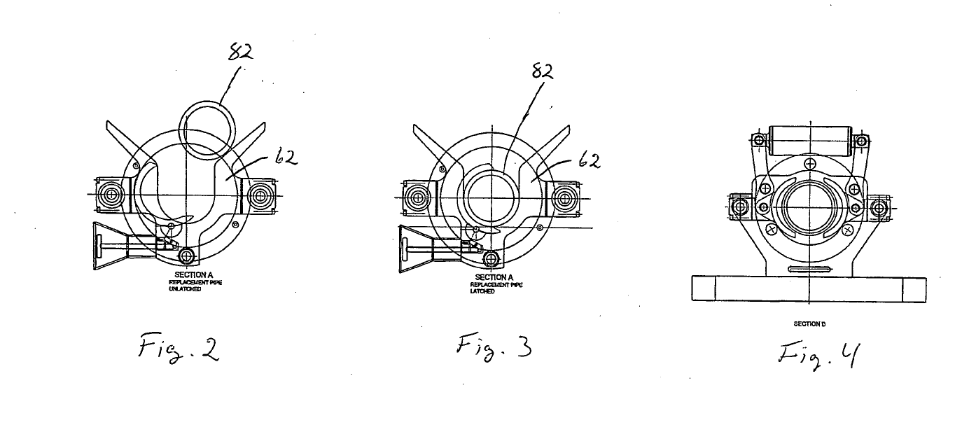

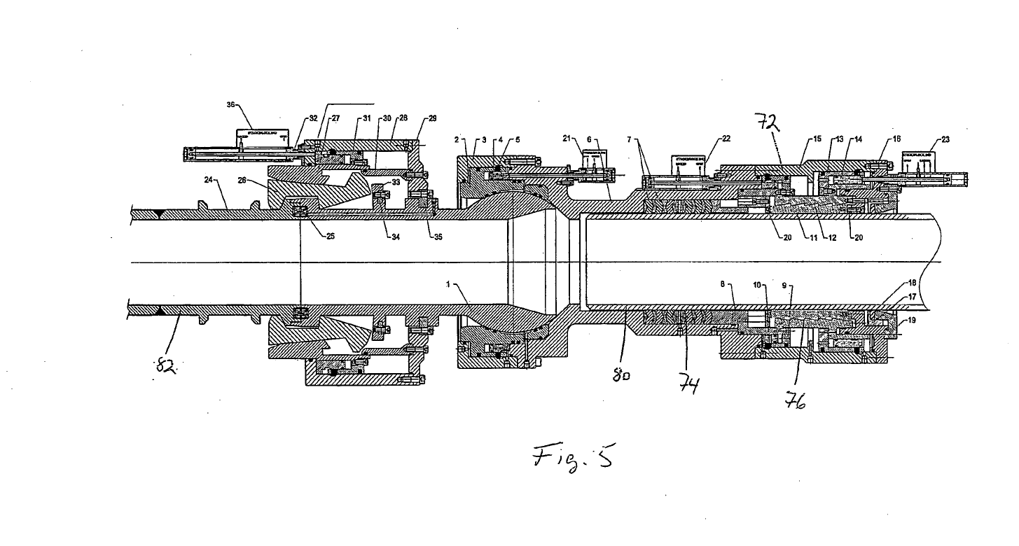

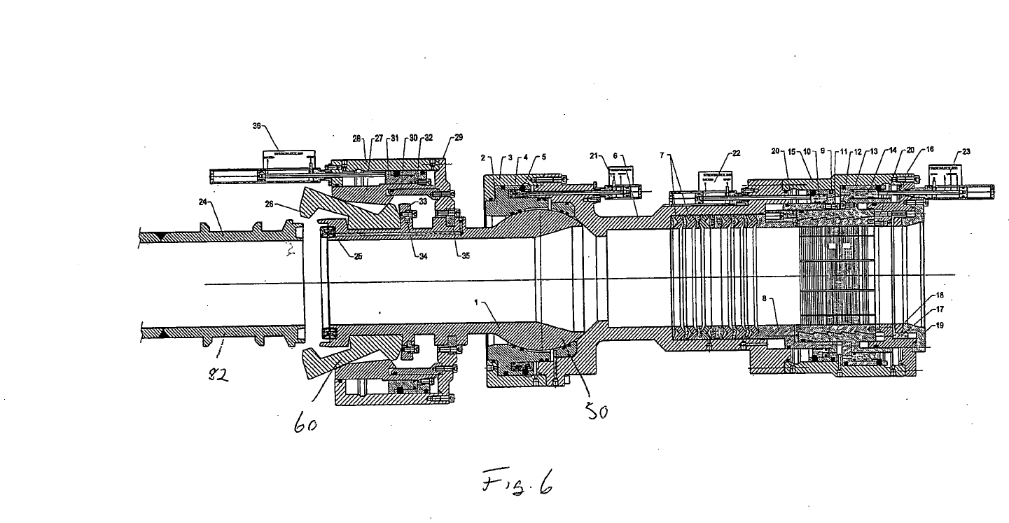

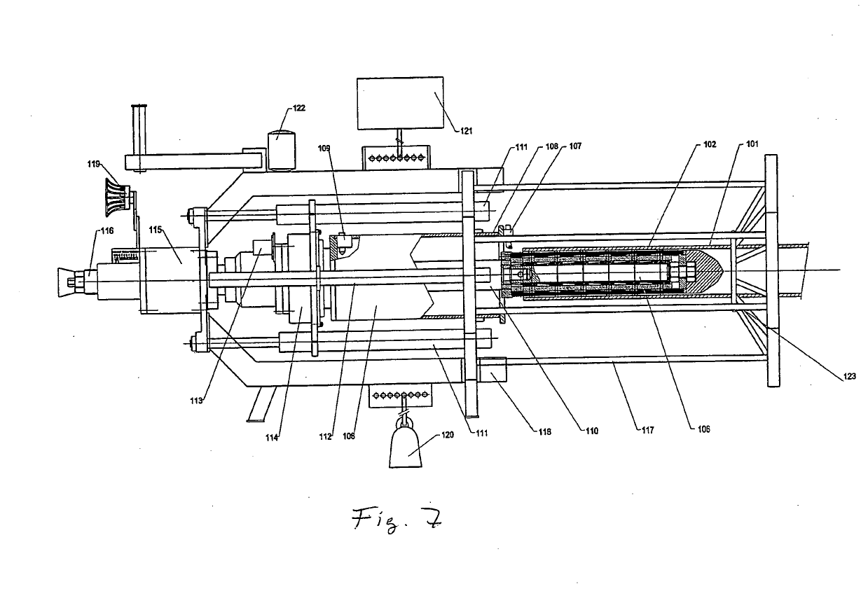

In front of the sealing coupling 60 is preferable a replacement pipe guide pulling tool 62, a replacement pipe pulling cylinder or pin 64, and a replacement pipe guide 66, in where all part are designed to ease connection of the replacement pipe to the quick sealing coupling system 60. FIGS. 2 and 3 shows placement of a replacement pipe with the help of the replacement guide pulling tool 62.

Connector operational advantages are quick and easy to hydraulic connect and disconnect operations of connectors HQS coupling and pipeline sealing and dripping system. For example, maximum 20 to 30 minutes. A safe and reliable visible indication system for control of close and open position of the pipe sealing and gripping system. Running and installation procedures that are efficient, and requires no extra handling and installation tool besides the tool that is permanently installed on the installation frame, that is included in the package.

There are hydraulic functions to open and close the ball joint during installation of the connectors 40 down to at least 2000 meters. The connector is provided with internal and external pressure test ports (facilities) to the following seals: pipeline seal, ball joint seal and HQS coupling seal.

Before the connectors are lowered to the ocean floor, a pipeline multifunction hydraulic adjustable lifting and positioning tool 440 is lowered to the ocean floor.

The multifunction hydraulic adjustable pipeline-lifting tool 440 can be used for several sub sea applications within the pipeline repair system. All functions are hydraulically operated from a ROV down to at least 2000 meter water depth. The pipeline adjustable lifting tool can operate on pipes of different dimensions, such as from 4″ to 20″ and lifting capacity from 12-24 tons. If required, divers in shallow water can operate this tool, by using hydraulic power pack and umbilical from a standard offshore vessel, but the pipeline lifting and positioning tool is preferable designed in connection with experienced ROV operators and can be operated from any standard deepwater ROV.

After the lifting and positioning tool 440 is in place on the ocean floor and supporting a pipeline, a preparation tool is lowered, comprising a single tooling package 140 for repairing radius and ovality defect and milling outer surface of pipeline to remove coating, pipe-welding seam and/or other defects and for finishing and bevelling end surface of pipe. The tooling package 140 is fitted with specially designed protection and guide frame to insure tooling package is not damaged during deployment and recovery. Front opening of guide frame designed to insure ease of deployment of tooling package onto pipe end.

Deep water rated inspection camera mounted on tooling package to monitor complete operation in real time. Tooling package can fitted with buoyancy blocks to render it neutral in water, and deployed using a clump weight attached to the bottom side of tool. Due to the tool being neutrally buoyant in water, attachment of the tool onto the pipeline is not affected by vessel heave.

It also has centrally located ROV intervention panel with docking point for ROV grabber for positioning of tooling package onto pipeline. Underwater mateable hydraulic and electrical connector c/w 4-meter umbilical for connection to ROV mounted stab plate, tooling package deployed with connector mounted in parking support on ROV intervention panel.

Extended control umbilicals insure that tooling package is not subject to vibration and movement of the ROV during operation and ROV is free to monitor operation from various locations. Hydraulic/electrical stab plate fitted with emergency fail-safe release mechanism in the case of loss of ROV hydraulics. Connector will automatically release allowing ROV to be recovered to surface for repair. Emergency manual override on mandrill extend and retract function to insure even in the case of complete hydraulic failure of system the mandrill can be released from pipeline using ROV mounted 1-¼″ torque tool. ROV intervention panel fitted with support for acoustic beacon to ease with positioning of tooling package. Visual indicators for all functions.

In the following, an example of a method for sub sea installation and testing of a replacement pipe is provided. However, it should be noted that many of the steps can be omitted depending on requirements and/or circumstances, and that the indicated depths, etc., are not absolute. The steps are carried out after the lifting and positions tool and the preparation tool are deployed.
1) Deploy ROV in water and inspect sub sea rigid pipe.
2) Deploy connector no. 1 complete with attached clump weight into water
3) Lower connector no. 1 and clump weight to depth, stopping 10-15 meters above seabed.
4) With assistance from ROV position connector no. 1 next to connection point on sub sea rigid pipe.
5) When connector no. 1 is within 3-6 meters from pipe, lower connector and clump weight so that clump weight sits on the seabed close to pipeline.
6) Pay out an additional crane cable, as connector no. 1 is neutrally buoyant in water, it will float and be touching the seabed by the clump weight.
7) Dock ROV onto connector no. 1 manoeuvring handles.
8) Guide neutrally buoyant connector no. 1 into ridged pipe, using ROV inspection camera, to insure that connector no 1 is fully deployed on ridged pipe.
9) Connect hydraulic “stab” multi connector to stab plate mounted on connector no. 1 control panel, using 7-function manipulator.
10) Activate hydraulic actuator on stab plate, ensure hydraulic “stab” multi connector is in fully connected position, by reading hydraulic “stab” position indicator.
11) Fully extend connector no. 1 positioning tool to position for pulling connector onto ridged pipe. (Operated from ROV control room)
12) Activate connector no. 1 position tool clamp. (Operated from ROV control room).
13) Action connector no 1 position tool to ensure the connector is fully deployed on ridged pipeline by reading connector positioning tool stroke indicator. (Operated from ROV control room).
14) Adjust position of ball joint in line with other pipe end by using ball joint positioning cylinders up/down and right/left function. (Operated from ROV control room)
15) Extend ½ stroke spool pulling and guide tool to be ready for receive spool pipe. (Operated from ROV control room)
16) Disconnect hydraulic “stab” multi connector from connector no. 1 hydraulic control panel.
17) Approach ROV with other pipe end.
18) Carry out installation procedure from sequence number 2 to 16 with connector no. 2.
19) Measurement survey can be performed at this stage.
19a) Photographing of each end by digital camera installed on ROV.
19 b) Transferring the images to the vessel.
19 c) Calculate the distance between the connectors based on the marks on the connector coupling.
20) Spool pipe fabrication on board
20 a) Cut pipe
20 b) Weld Hub (pin) coupling connection on spool, both end.
20 c) Carry out weld survey.
20 d) Hydrostatic tests can be preformed if necessary.
20 e) Apply corrosion protections on both welds.
21) Connect crane or other launching system to spool pipe-lifting sling.
22) Confirm that spool pipe sitting in a level position.
23) Connect clump weight if necessary.
24) Deploy spool pipe complete with attached clump weight into water.
25) Lower spool pipe and clump weight to depth, stopping 10-15 meters above seabed.
26) With assistance from ROV position spool pipe above connectors spool guide tools funnels.
27) Slowly lower spool pipe into spool guide tools funnels on both end.
28) Connect hydraulic “stab” multi connector to stab plate on connector no. 2, using 7-functions manipulator
29) Activate hydraulic actuator on stab plate, insure hydraulic “stab” multi connector is in fully connected position, by reading hydraulic “stab” position indicator (Operated from ROV control room).
30) Adjust position of spool pooling and guide tool of connector no. 2 by using ball joint position cylinders until spool pipe weld end connection engage in pulling and guide tool saddle. (Operated from ROV control room)
31) When spool pipe is fully engaged in spool guide saddle, clamp arm will automatically close and secure spool pipe.
32) Disconnect hydraulic “stab” multi connector from stab plate on connector no. 2.
33) Reposition ROV to other end.
34) Connect hydraulic “stab” multi connector to stab plate on connector no. 1
35) Activate hydraulic actuator on stab plate, insure hydraulic “stab” multi connector is in fully connected position, by reading stab position indicator. (Operated from ROV control room).
36) Adjust position of spool pulling guide tool by using ball joint positioning cylinders until spool pipe weld end engage in pulling and guide tool saddle. (Operated from ROV control room)
37) When spool pipe is fully engaged in guide saddle clamp, arm will automatically secure spool pipe.
38) Adjust spool weld end connection hub into coupling by retracting spool pipe pulling and guide tool and pushing out connector no. 1 by connector positioning tool in same time. (Operated from ROV control room).
39) Insure the spool pipe weld end hub is in position for actuate coupling by reading spool pulling and guide tool stroke indicator.
40) Turn hydraulic functions change over valve from position hydraulic functions group no. 1 to hydraulic functions group no. 2 mounted on hydraulic control panel of hydraulic connector no. 2 using 7-function manipulator.
41) Actuate coupling to compress metal gasket and connect spool pipe by apply closing hydraulic pressure to coupling operation cylinder. (Operated from ROV control room)
42) When locking cone is in the “look” position the coupling stroke/lock indicator will show locked.
43) The coupling closing pressure can now be vented and the stretch in the components is transferred as pre-load to the locking device. (Operated from ROV control room)
44) Actuate seals/gripping operated cylinder by apply closing hydraulic pressure. (Operated from ROV control room)
45) Closing hydraulic pressure will firstly push towards seals compression operating piston to compress seal set. Once full compression stroke is reached, the seals compression stroke/locked indicator will show Locked.
46) By continue pressurize closing pressure in the seals/gripping operating cylinder, the gripping operating piston is pushed towards to increase the gripping force.
47) The hydraulic seal/gripping closing pressure now can be vented and components load will be transferred to the locking device. (Operated from ROV control room)
48) Actuate ball joint by apply closing pressure to ball joint operating cylinder. (Operated from ROV control cabin).
49) When full stroke is reached and locking cone in locking position the ball joint stroke/lock indicator will show locked.
50) The ball joint closing pressure now can be vented and components load will be transferred to the locking device. (Operated from ROV control room).
51) Close metal gasket external pressure test isolation valve and ball joint seal external pressure test isolation valve located on connector hydraulic control panel, using 7-functions manipulator.
52) Ensure the pipe “seals” external pressure test isolation valve is open.
53) Apply pressure to pipe “seals” external test chamber. (Operated from ROV control room)
54) Close pipe “seals” external pressure test isolation valve, using 7-functions manipulator.
55) Read testing pressure on pipe “seals” external press. test gauge located on connectors hydraulic control panel.
56) Open ball joint external pressure test valve located on hydraulic control panel using 7-functions manipulator.
57) Apply pressure to ball joint external pressure testing chamber. (Operated from ROV control room)
58) Close ball joint external pressure test isolation valve, using 7-function manipulator.
59) Read testing pressure on ball joint external pressure test gauge located on hydraulic control panel.
60) Open metal gasket external pressure test isolation valve located on hydraulic control panel.
61) Apply hydraulic pressure to coupling metal gasket external pressure chamber. (Operated from ROV control room)
62) Close coupling metal gasket external pressure test isolation valve located on hydraulic control panel, using 7-functions manipulator.
63) Read testing pressure on coupling metal gasket external pressure test gauge, located on hydraulic control panel.
64) Continue monitoring testing pressure drop/time on all pressure test gauges.
65) When the connector test is completed, testing pressure gauges multi isolation valve to be turned to close position, using 7-function manipulator
66) Open corrosion inhibitor isolate valve located on hydraulic control panel, using 7-functions manipulator
67) Corrosion inhibiting fluid will flow from storage/compression cylinder to connector griping/sealing system to protect internal components.
68) Ensure that corrosion inhibiting fluid is charged to connector, this can be done by reading corrosion storage cylinder stroke indicator.
69) Close corrosion inhibiting isolating valve, using 7-function manipulator
70) Turn hydraulic functions change over valve from position hydraulic functions group no. 2 to close, using 7-functions manipulator
71) Disconnect hydraulic “stab” multi connector from hydraulic control panel of connector no. 1
Connection of Connector No. 1 Completed
72) Reposition ROV to connector no. 2.
73) Connect hydraulic “stab” multi connector to stab plate mounted on connector no. 2 hydraulic control panel.
74) Activate hydraulic actuator on stab plate, ensure stab multi connector is in fully connected position by reading hydraulic “stab” position indicator. (Operated from ROV control room)
75) Carry out installation procedure from sequence number 38 to 71 with connector no. 2.
76) Disconnect buoyancy blocks from both connectors and rise to surface
77) Check once again all indicators on both connectors.

Pipeline Repair Installation Completed

To further increase the understanding of the invention, a part list is provided below.

Parts list in the drawings for the connector 40:

| | |
|---|---|
| 1 | LONG NECK BALL JOINT |
| 2 | BALL JOINT PISTON |
| 3 | BALL JOINT CYLINDER |
| 4 | BALL JOINT LOCKING CONE |
| 5 | LOCKING SEGMENT |
| 6 | CONNECTOR HOUSING |
| 7 | PIPE SEAL SET |
| 8 | SEAL SET COMPRESSION BUSH |
| 9 | SEAL COMPRESSION PISTON |
| 10 | LOCKING CONE |
| 11 | GRIPPING INTERNAL BUSH |
| 12 | GRIPPING OUTER BUSH |
| 13 | GRIPPING SYSTEM PISTON |
| 14 | 3 STAGE LOCKING CONE |
| 15 | SEAL/GRIPPING SYSTEM SYLINDER |
| 16 | CONNECTOR COVER |
| 17 | ENVIRONMENTAL SEAL COMPRESSION RING |
| 18 | ENVIRONMENTAL SEAL |
| 19 | ENVIRONMENTAL SEAL COVER |
| 20 | GRIPPING BUSH SPACER RING |
| 21 | BALL JOINT STROKE/LOCKING INDICATOR |
| 22 | SEAL COMRESSION STROKE/LOCKING INDICATOR |
| 23 | GRIPPING STROKE/MULIT-POSITION LOCK INDICATOR |
| 24 | REPLACEMENT PIPE PIN END WELD CONNECTION |
| 25 | METAL RING GASKET |
| 26 | CLAMP SEGMENTS |
| 27 | CLAMP SEGMENTS ACTUATOR RING |
| 28 | HYD. CYLINDER |
| 29 | CYLINDER COVER/CARRIER |
| 30 | HYD. CYLINDER INTERNAL BUSH |
| 31 | LOCKING CONE |
| 32 | COUPLING PISTON |
| 33 | CLAMP SEGMENTS GUIDE LOAD RING |
| 34 | SEGMENTS GUIDE LOAD RING |
| 35 | COUPLING LOAD RING |
| 36 | COUPLING STOKE/LOCK INDICATOR |

Parts list in the drawings for the preparation tool 140:

| | |
|---|---|
| 101 | PIPE |
| 102 | MULTI PIN MANDREL |
| 103 | CONE |
| 104 | PIN |
| 105 | BEAM |
| 106 | MANDREL HYD. CYLINDER ROD |
| 107 | FRONT CUTTING TOOL |
| 108 | BELL (TOOL HOLDER) |
| 109 | BEVELLING CUTTING TOOL |
| 110 | MAIN SHAFT |
| 111 | TRAVEL HYD. CYLINDER (AXIAL FEED) |
| 112 | GREASE RESERVOIR |
| 113 | HYDRAULIC MOTOR |
| 114 | GEAR BOX |
| 115 | MANDREL HYD. CYLINDER |
| 116 | MANDREL EMERGENCY RELEASE |
| 117 | PROTECTION CAGE |
| 118 | CARRIER CONSOLE |
| 119 | MULITIFUNCTION HYD. QUICK CONNECTOR |
| 120 | CLUMP WEIGHT |
| 121 | FLOAT |
| 122 | PRESSURE COMPENSATOR |
| 123 | PIPE FUNNEL GUIDE |

Parts list in the drawings for the lifting tool 440.

| | |
|---|---|
| 401 | MAIN FRAME |
| 402 | TROLLEY |
| 403 | YELESCOPIC LIFTING HYD. CYLINDER |
| 404 | LIFTING HEAD |
| 405 | JAW |
| 406 | JAW OPERATING HYD. CYLINDER |
| 407 | LIFTING HEAD BALL JOINT LOWER HALF |
| 408 | LIFTING HEAD BALL JOINT UPPER HALF |
| 409 | GANTRY |
| 410 | HORIZONTAL GANTRY BEAM |
| 411 | LEVELING HYD. CYLINDER |
| 412 | GANTRY EXTENDED HYD. CYLINDER |
| 413 | FOOT |
| 414 | LIFTING TROLLEY OPERATING HYD. CYLINDER |

1. A pipeline repair connector (40), for a sub sea pipeline system, arranged to be lowered to the ocean floor for replacement of pipelines on the ocean floor, wherein the connector comprises a connector housing (6) for gripping and sealing of the pipeline ends, and an inlet funnel for receipt of at least one of said pipeline ends, characterized in that a first part of said housing (6) comprises a pressurized gripping and sealing arrangement (70) for receipt and gripping of an existing pipeline end (80) in the connector housing (6), and a second part of said housing (6) comprises a pressurized operated quick sealing light weight coupling (60) (HQS) for receipt and gripping of a replacement pipe (82) in the connector housing (6), and intermediate between said housing ends is a pressurized alignment ball joint (50), wherein all components are adapted to be hydraulically pressurized to a mechanical locking position and to provide a seal to the surrounding.

2. Repair connector according to claim 1, wherein the gripping and sealing arrangement (70) comprises a seal set hydraulic system designed with preferable a one position-locking device, and a gripping hydraulic system designed with preferable a multi-locking device.

3. Repair connector according to claim 2, wherein the gripping and sealing arrangement (70) comprises at least one of: a connector hydraulic cylinder (15), a seal set compression hydraulic operating piston (9), a gripping hydraulic operating piston (13), a seal set compression bush (8), a gripping outer bush (12), a seal set locking cone (10), a gripping multi-lock locking cone (14), a seal set locking segments, and gripping multi stage locking segments.

4. Repair connector according to claim 1, wherein said alignment ball joint (50) of the pipeline repair connector (40) is a hydraulically operated ball joint of flex type connection, with elastomer seals, comprising at least two pressurized cylinders (52) for position and adjustment of correct ball joint alignment, designed to compensate misalignments of pipeline up to at least 14 degrees in any direction, wherein a hydraulic actuator is designed with a position “lock device”, to maintain seal and ball joint in contact, when the hydraulic system has a maximum internal pressure and maximum bending encountered.

5. Repair connector according to claim 4, wherein said alignment ball joint (50) comprises at least one of: a ball joint hydraulic operating piston (2), a locking cone (4), an operating cylinder (3), and locking segments (5).

6. Repair connector according to claim 1, wherein the hydraulic quick sealing coupling (60) of the pipeline repair connector (40) is a hub/clamp connection with a metal-to-metal sealing system, designed with at least one operating annular piston/actuator with a large piston area which creates a high closing force.

7. Repair connector according to claim 6, wherein the dynamic parts of the quick sealing coupling (60) is designed with a “position lock” device to maintain metal-to-metal sealing contact when the systems maximum internal pressure and maximum bending moments have been encountered, and wherein the metal-to-metal sealing system comprises a metal gasket ring which provide high-pressure seal between the hubs.

8. Repair connector according to claim 7, wherein the quick sealing coupling system (60) of the pipeline repair connector (40) comprises at least the following parts; a hydraulic coupling operating cylinder (28), a coupling operating piston (32), a locking cone (31), a coupling clamp actuator ring (27), a coupling clamp segments (26), a ball joint long neck (1), and a metal gasket (25).

9. System for replacement of pipelines on the ocean floor, comprising a pipeline repair connector according to any of claims 1-8, and a hydraulic preparation tool (140) comprising an elongated body with a pressurized mandrel (102) on one end for receipt of a pipe end, adapted for repairing radius and ovality defects, and a movable milling- and beveling tool (109) for milling outer surface of the pipe to remove coating, pipe welding seam and/or other defects and also for finishing and beveling end surface of pipe, and further comprising a protection and guide frame (123) adapted for deployment onto a pipe end.

10. System according to claim 9, further comprising a adjustable lifting and positioning tool (440), comprising a plurality of pressurized cylinders adapted to level the tool under operation on the ocean floor, and to increase tool stability and to adjust position of tool legs, a gripping means for gripping the pipeline, and a plurality of pressurized cylinder for positioning and lifting of the pipeline.

11. Method for replacement of broken pipelines on the ocean floor, including at least the following steps:
a) to lower a lifting and positioning tool (440) from the surface and down to the ocean floor, and to lift and position a first pipeline end on the ocean floor,
b) to lower a preparation tool (140) from the surface and down to the ocean floor, and to insert said pipeline end into the preparation tool, and to repair radius and ovality defects, and milling the outer surface of the pipeline end,
c) to lower a first pipeline repair connector (40) from the surface and down to the ocean floor, and to connect the repair connector to said pipeline end,
d) repeating steps a) to c) on another pipeline end for a second pipeline repair connector (40),
e) to lower a replacement pipeline to the ocean floor and to clamp the ends of the replacement pipeline into each of the repair connectors.

12. Method according to claim 11, wherein the connectors during or after installation is subjected to internal and external pressure tests, in ports to the following seals: pipeline seal, ball joint seal and HQS coupling seal.
